(19) United States
(12) Patent Application Publication
(10) Pub. No.: US 2025/0173184 A1
(43) Pub. Date: May 29, 2025

(54) DEVICE AND METHOD FOR RECOMMENDING PIPELINES FOR ENSEMBLE MODEL

(71) Applicant: Industrial Technology Research Institute, Hsinchu (TW)

(72) Inventors: Jia-Min Ren, Hsinchu City (TW); Chuang-Hua Chueh, Taipei City (TW); Huan-Yi Pan, Taoyuan City (TW); Wei-Hsuan Liu, Taoyuan City (TW)

(73) Assignee: Industrial Technology Research Institute, Hsinchu (TW)

(21) Appl. No.: 18/619,177

(22) Filed: Mar. 28, 2024

(30) Foreign Application Priority Data
Nov. 29, 2023 (TW) 112146192

(51) Int. Cl. G06F 9/50

(52) U.S. Cl. CPC G06F 9/5027

(57) ABSTRACT

A device and a method for recommending pipelines for an ensemble model are provided. The method includes: using an algorithm to generate an initial pipeline; using a dataset to obtain a prediction result corresponding to the initial pipeline, and using the dataset to obtain an accuracy corresponding to the initial pipeline; using, the prediction result, the accuracy, and a new pipeline to obtain an inter algorithm diversity value, an inter feature correlation value and an intra algorithm hyperparameter distance value, and using the inter algorithm diversity value, the inter feature correlation value, and the intra algorithm hyperparameter distance value to obtain a sampling score corresponding to the new pipeline; using the sampling score to determine a recommended new pipeline in the new pipeline; and using an ensemble learning method to select a target recommended new pipeline from the recommended new pipelines.

### CROSS-REFERENCE TO RELATED APPLICATION

This application claims the priority benefit of Taiwan application serial no. 112146192, filed on Nov. 29, 2023. The entirety of the above-mentioned patent application is hereby incorporated by reference herein and made a part of this specification.

### TECHNICAL FIELD

The present disclosure relates to a device and a method for recommending pipelines for an ensemble model.

### BACKGROUND

Artificial intelligence (AI) technologies are combined and constructed based on models trained by machine learning, deep learning, ensemble learning or reinforcement learning. In the general artificial intelligence machine learning applications, the data scientific processing process is, data scientists first collect a large amount of data, and after going through data exploration, data processing, model selection, feature engineering, model evaluation and constant adjustment of parameters, finally a useful model is trained. However, whether it is building training data, selecting models, finding combinations of hyperparameters based on experience, etc., data scientists need to manually build the best model in a batch execution manner. After the model is built, the same manual batch method is also used for data pre-processing, model inference and data post-processing to integrate application use, and this batch process is continuously repeated to maintain the accuracy of the inference results. To reduce the time for data scientists to manually and empirically find the best combination of hyperparameters, automated machine learning (AutoML) technology that can more efficiently search for hyperparameter combinations has gradually received attention.

In automated machine learning (AutoML) technology, the ensemble learning is often used as one of the techniques to select the best combination from a plurality of sets of hyperparameter combinations. However, it currently lacks methods for accurately recommending pipelines (that is, combinations of hyperparameters) for the ensemble learning.

### SUMMARY

The present disclosure provides a device and a method for recommending pipelines for an ensemble model, which can more accurately recommend pipelines for an ensemble model.

The device of the present disclosure for recommending pipelines for an ensemble model includes a storage medium and a processor. The storage medium stores a plurality of modules, wherein the plurality of modules include a data acquisition and pipeline initialization module, a pipeline performance evaluation module, a pipeline sampling score calculation module, a pipeline recommendation module and an ensemble model recommendation module. The processor is coupled to the storage medium, and accessing and executing the plurality of modules, wherein the data acquisition and pipeline initialization module uses an algorithm to generate an initial pipeline; the pipeline performance evaluation module uses a dataset to obtain a prediction result corresponding to the initial pipeline, and uses the dataset to obtain an accuracy corresponding to the initial pipeline; the pipeline sampling score calculation module uses the prediction result, the accuracy, and a new pipeline to obtain an inter algorithm diversity value, an inter feature correlation value, and an intra algorithm hyperparameter distance value, and the pipeline sampling score calculation module uses the inter algorithm diversity value, the inter feature correlation value, and the intra algorithm hyperparameter distance value to obtain a sampling score corresponding to the new pipeline; the pipeline recommendation module uses the sampling score to determine a recommended new pipeline in the new pipelines; the ensemble model recommendation module uses an ensemble learning method to select a target recommended new pipeline from the recommended new pipelines.

The method of the present disclosure for recommending pipelines for an ensemble model includes following steps: using, by the data acquisition and pipeline initialization module, an algorithm to generate an initial pipeline; using, by the pipeline performance evaluation module, a dataset to obtain a prediction result corresponding to the initial pipeline, and using the dataset to obtain an accuracy corresponding to the initial pipeline; using, by the pipeline sampling score calculation module, the prediction result, the accuracy, and a new pipeline to obtain an inter algorithm diversity value, an inter feature correlation value and an intra algorithm hyperparameter distance value, and using, by the pipeline sampling score calculation module, the inter algorithm diversity value, the inter feature correlation value, and the intra algorithm hyperparameter distance value to obtain a sampling score corresponding to the new pipeline; using, by the pipeline recommendation module, the sampling score to determine a recommended new pipeline in the new pipeline; and using, by the ensemble model recommendation module, an ensemble learning method to select a target recommended new pipeline from the recommended new pipelines.

Based on the above, the device and the method for recommending pipelines for an ensemble model of the present disclosure can generate an initial pipeline and obtain the prediction results and the accuracy of the initial pipeline, and then use the inter algorithm diversity value, the inter feature correlation value, and the intra algorithm hyperparameter distance value to obtain the sampling score of the new pipeline. Then, the sampling score of the new pipeline can be used to recommend pipeline for the ensemble model. In this way, the device and the method for recommending pipelines for an ensemble model of the present disclosure can more accurately obtain the sampling score of the new pipeline, thereby more accurately recommending the pipeline for the ensemble model.

### BRIEF DESCRIPTION OF THE DRAWINGS

FIG. 1 is a schematic diagram of a device for recommending pipelines for an ensemble model according to an embodiment of the present disclosure.

FIG. 2 is a flowchart illustrating a method for recommending pipelines for an ensemble model according to an embodiment of the present disclosure.

FIG. 3 is an implementation example of step S210 shown in FIG. 2.

FIG. 4 is an implementation example of step S220 shown in FIG. 2.

FIGS. 5A to 5C are an implementation example of step S230 shown in FIG. 2.

FIG. 6 is an implementation example of step S240 shown in FIG. 2.

FIG. 7 is an implementation example of step S260 shown in FIG. 2.

### DESCRIPTION OF THE EMBODIMENTS

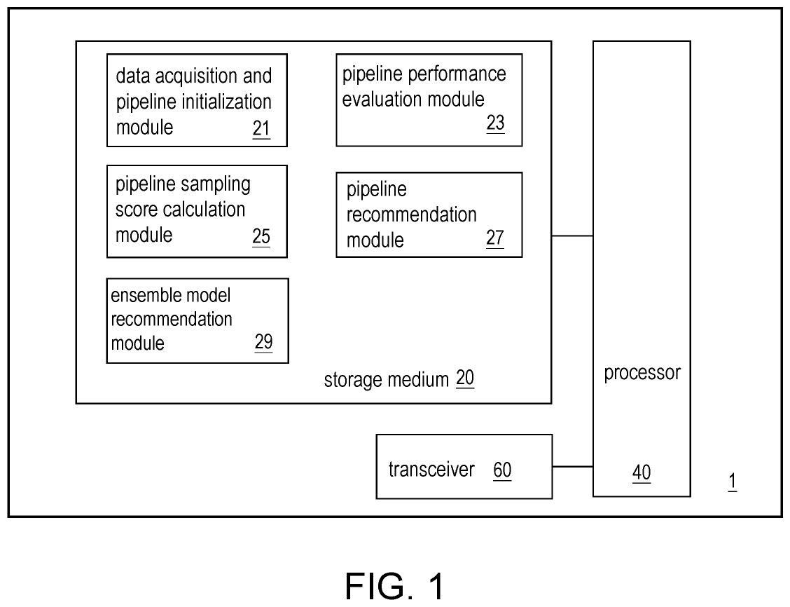

FIG. 1 is a schematic diagram of a device 1 for recommending pipelines for an ensemble model according to an embodiment of the present disclosure. Please refer to FIG. 1. The device 1 can include a storage medium 20 and a processor 40. The processor 40 is coupled to the storage medium 20. In other embodiments, the device 1 can further include a transceiver 60 coupled to the processor 40.

The storage medium 20 is, for example, any type of fixed or removable random access memory (RAM), read-only memory (ROM), flash memory, hard disk drive (HDD), solid state drive (SSD) or similar components or a combination of the above components, used to store a plurality of modules or various applications that can be executed by the processor 40. In this embodiment, the storage medium 20 can store the data acquisition and pipeline initialization module 21, the pipeline performance evaluation module 23, the pipeline sampling score calculation module 25, the pipeline recommendation module 27, and the ensemble model recommendation module 29. The functions of these modules will be explained later.

The processor 40 is, for example, a central processing unit (CPU), or other programmable general-purpose or special-purpose micro control unit (MCU), microprocessor, or digital signal processor (DSP), programmable controller, application specific integrated circuit (ASIC), graphics processor unit (GPU), image signal processor (ISP), image processing unit (IPU), arithmetic logic unit (ALU), complex programmable logic device (CPLD), field programmable gate array (FPGA) or others Similar elements or combinations of the above elements. The processor 40 can access and execute a plurality of modules and various applications stored in the storage medium 20.

The transceiver 60 transmits and receives signals in a wireless or wired manner.

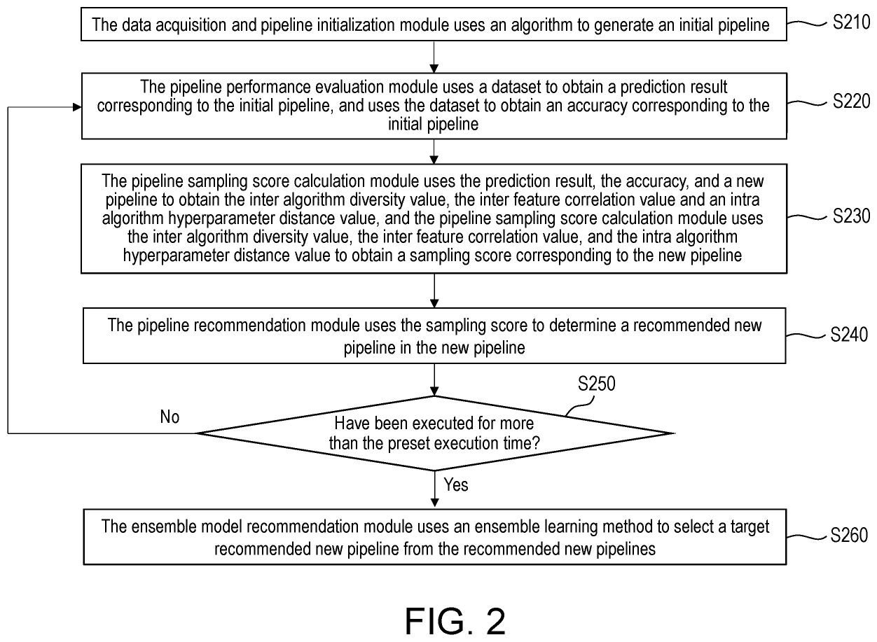

FIG. 2 is a flowchart illustrating a method for recommending pipelines for an ensemble model according to an embodiment of the present disclosure, wherein the method can be implemented by the device 1 shown in FIG. 1. Please refer to both FIG. 1 and FIG. 2.

In step S210, the data acquisition and pipeline initialization module 21 can use an algorithm to generate an initial pipeline.

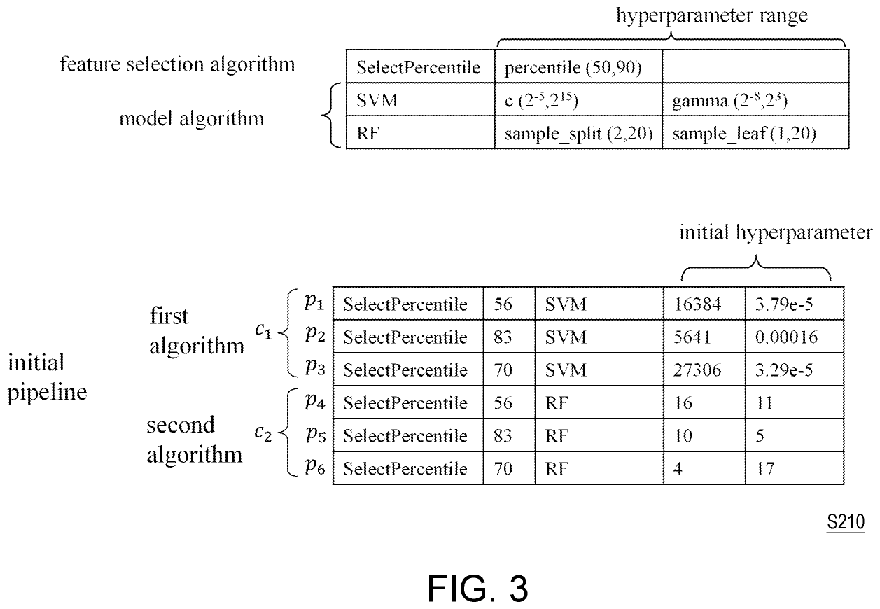

FIG. 3 is an implementation example of step S210 shown in FIG. 2. Please refer to FIG. 1, FIG. 2 and FIG. 3 at the same time. In this embodiment, the data acquisition and pipeline initialization module 21 can receive the algorithm, a hyperparameter range, an initial number, a preset number of target pipeline, and a training time through the transceiver 60. Then, the data acquisition and pipeline initialization module 21 can use the algorithm, the hyperparameter range, the initial number, the preset number of target pipeline, and the training time to generate the initial pipeline. Furthermore, the algorithm can include a feature selection algorithm and a model algorithm. In detail, the feature selection algorithm can be SelectPercentile, KBest (SelectKBest), Variance Threshold Univariate Feature Selection, or Recursive Feature Elimination (RFE). On the other hand, the model algorithm can be Support Vector Regression (SVR), Support Vector Machine (SVM), Random Forest (RF), Decision Tree, Extra Trees, AdaBoost, Gradient Boosting, XGBoost, or K-Nearest-Neighbor (KNN).

It is assumed that the initial number which data acquisition and pipeline initialization modules 21 received through the transceiver 60 is 3 (that is, the data acquisition and pipeline initialization module 21 needs to generate 3 initial pipelines for each algorithm), and the training time received through the transceiver 60 is, for example, 60 minutes. As shown in FIG. 3, after the data acquisition and pipeline initialization module 21 also receives the algorithm (i.e., SelectPercentile, SVM, and RF) and the hyperparameter range through the transceiver 60, the data retrieval and pipeline the initialization module 21 can generate initial pipeline P₁, initial pipeline P₂, initial pipeline P₃, initial pipeline P₄, initial pipeline P₅ and initial pipeline P₆. Specifically, in this embodiment, the algorithm can include a first algorithm (that is, a combination of SelectPercentile and SVM) and a second algorithm (that is, a combination of SelectPercentile and RF), wherein the first algorithm is different from the second algorithm. Furthermore, the initial pipeline can include a first initial pipeline (initial pipeline P₁, initial pipeline P₂, and initial pipeline P₃) and a second initial pipeline (initial pipeline P₄, initial pipeline P₅, and initial pipeline P₆). The initial hyperparameter can correspond to the initial pipeline. The initial hyperparameter can include a first initial hyperparameter and a second initial hyperparameter. The first initial pipeline can include the first initial hyperparameter corresponding to the first algorithm, and the second initial pipeline can include the second initial hyperparameter corresponding to the second algorithm. For example, as shown in FIG. 3, the initial pipeline P₁ of the first initial pipeline can include the first initial hyperparameter 16384 and 3.79e-5 corresponding to the first algorithm C₁, the combination of SelectPercentile and SVM. Specifically, 16384 can be the value of the initial hyperparameter c of the SVM, and 3.79e-5 can be the value of the initial hyperparameter gamma of the SVM. On the other hand, the initial pipeline P₄ of the second initial pipeline can include second initial hyperparameter 16 and 11 corresponding to the second algorithm C₂, the combination of SelectPercentile and RF. Specifically, 16 and 11 can be the values of the initial hyperparameter of the RF.

Please return to FIG. 2. In step S220, the pipeline performance evaluation module 23 can use the dataset to obtain the prediction result corresponding to the initial pipeline, and can use the dataset to obtain the accuracy corresponding to the initial pipeline.

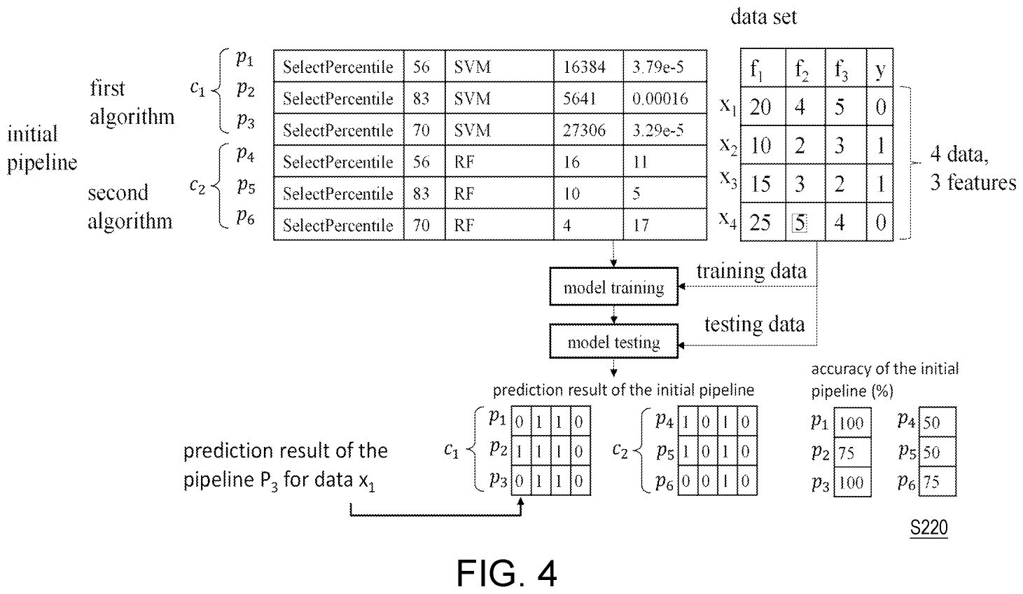

FIG. 4 is an implementation example of step S220 shown in FIG. 2. Please refer to FIG. 1, FIG. 2, FIG. 3 and FIG. 4 at the same time. In this embodiment, the data acquisition and pipeline initialization module 21 can receive the dataset through the transceiver 60. In one embodiment, the pipeline performance evaluation module 23 can use a kernel-based method (such as Gaussian Process) and a dataset to obtain the prediction result (corresponding to the initial pipeline), and can use the kernel-based method and the dataset to obtain the accuracy (corresponding to the initial pipeline). In other words, the pipeline performance evaluation module 23 can use the dataset to respectively train and test (predict) initial pipeline P₁, initial pipeline P₂, initial pipeline P₃, initial pipeline P₄, initial pipeline P₅ and initial pipeline P₆ to obtain the prediction result and the accuracy of these initial pipelines. For example, as shown in FIG. 4, the dataset can include 4 data, including data x₁, data x₂, data x₃, and data x₄, and the dataset can include a plurality of features (3 features, including feature f₁, feature f₂, and feature f₃). Furthermore, assuming that the prediction result of the initial pipeline P₃ for data x₁ is “0”, the prediction result of the initial pipeline P₃ for data x₂ is “1”, the prediction result of the initial pipeline P₃ for data x₃ is “1” and the prediction result of the initial pipeline P₃ for data x₄ is “0”. Then, the pipeline performance evaluation module 23 can obtain the accuracy of the initial pipeline P₃. For example, the pipeline performance evaluation module 23 can use a classification evaluation metric to obtain the accuracy of a specific initial pipeline. Classification evaluation metrics can include Accuracy, F1-score, and the Area under the Receiver Operating Characteristic Curve (AUC). It is assumed here that the pipeline performance evaluation module 23 obtains the accuracy of “100%” for the initial pipeline P₃. The pipeline performance evaluation module 23 can obtain the prediction results and accuracies of other initial pipelines in a similar manner. It should be noted here that although this embodiment uses “classification” as an implementation example to illustrate, the present disclosure is not limited thereto. In other embodiments, for the “regression” implementation example, the pipeline performance evaluation module 23 can use a regression evaluation metric to obtain the accuracy of a specific pipeline. Regression evaluation metrics can include Root of Mean Square Error (RMSE), Mean Square Error (MSE), R-square, Mean Absolute Error (MAE), and Mean Absolute Percentage Error (MAPE).

Furthermore, the prediction result can include a first prediction result and a second prediction result, and the accuracy can include a first accuracy and a second accuracy. The first prediction result can correspond to the first initial pipeline, and the first accuracy can correspond to the first initial pipeline; the second prediction result can correspond to the second initial pipeline, and the second accuracy can correspond to the second initial pipeline. The first initial pipeline can include a first best accuracy initial pipeline and a first other initial pipeline, wherein the first accuracy of the first best accuracy initial pipeline is greater than the first accuracy of the first other initial pipeline, wherein the first best accuracy initial pipeline corresponds to the first best accuracy initial pipeline prediction result. The second initial pipeline can include a second best accuracy initial pipeline and a second other initial pipeline, wherein the second accuracy of the second best accuracy initial pipeline is greater than the second accuracy of the second other initial pipeline, wherein the second best accuracy initial pipeline corresponds to the second best accuracy initial pipeline prediction result. For example, as shown in FIG. 4, since the initial pipeline P₁ and initial pipeline P₃ have the highest accuracy in the first initial pipeline (initial pipeline P₁, initial pipeline P₂ and initial pipeline P₃), the initial pipeline P₁ and initial pipeline P₃ are the above-mentioned first best accuracy initial pipeline, and the initial pipeline P₂ is the above-mentioned first other initial pipeline. Similarly, the initial pipeline P₆ is the above-mentioned second best accuracy initial pipeline, and the initial pipeline P₄ and the initial pipeline P₅ are the above-mentioned second other initial pipeline. Furthermore, the first best accuracy initial pipeline prediction result is the first prediction result “0, 1, 1, 0” of the first best accuracy initial pipeline (initial pipeline P₁ and initial pipeline P₃). On the other hand, the second best accuracy initial pipeline prediction result is the second prediction result “0, 0, 1, 0” of the second best accuracy initial pipeline (initial pipeline P₆).

It should be noted here that although the above steps S210 and step S220 are based on the first algorithm (that is, the combination of SelectPercentile and SVM) and the second algorithm (that is, the combination of SelectPercentile and RF) as two algorithms used for implementation examples, the number of algorithms in the present disclosure can be adjusted according to actual needs. In other words, the number of algorithms can be two or more.

Please return to FIG. 2. In step S230, the pipeline sampling score calculation module 25 can use the prediction result, the accuracy, and a new pipeline to obtain the inter algorithm diversity value, the inter feature correlation value and an intra algorithm hyperparameter distance value, and the pipeline sampling score calculation module 25 can use the inter algorithm diversity value, the inter feature correlation value, and the intra algorithm hyperparameter distance value to obtain a sampling score corresponding to the new pipeline.

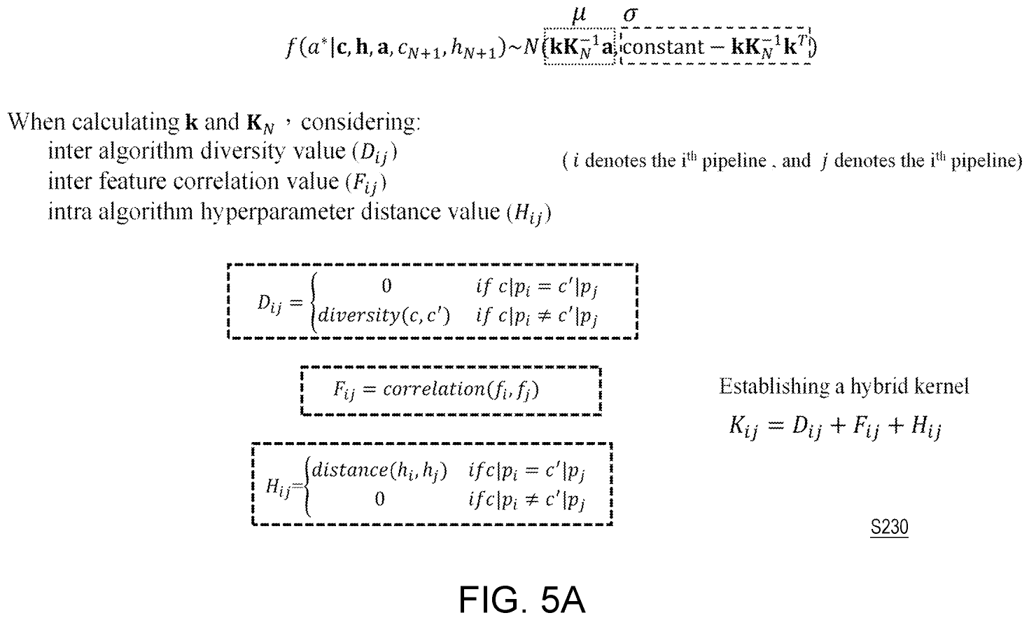

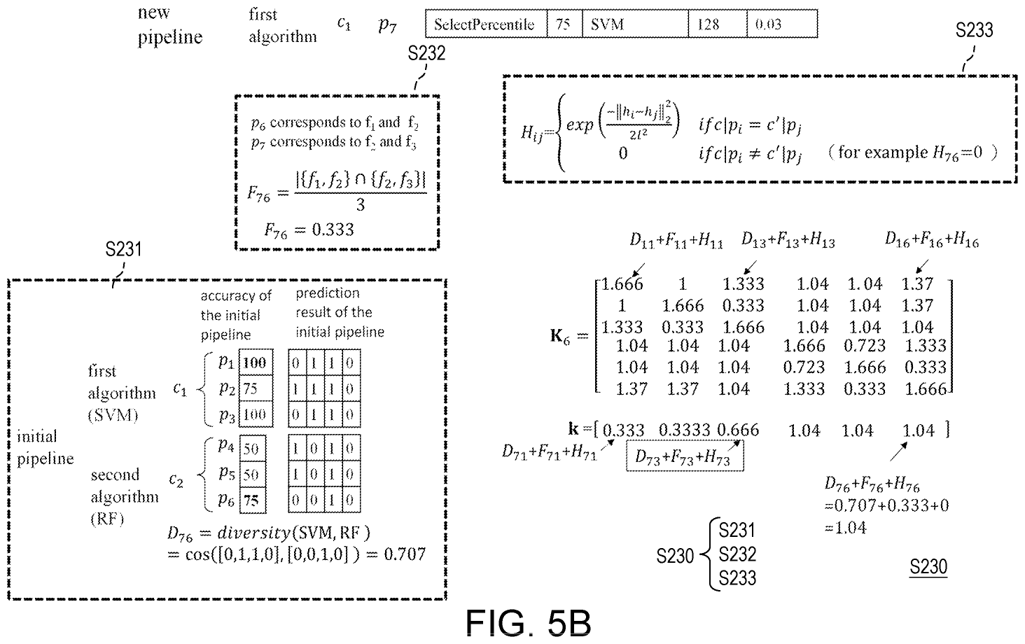

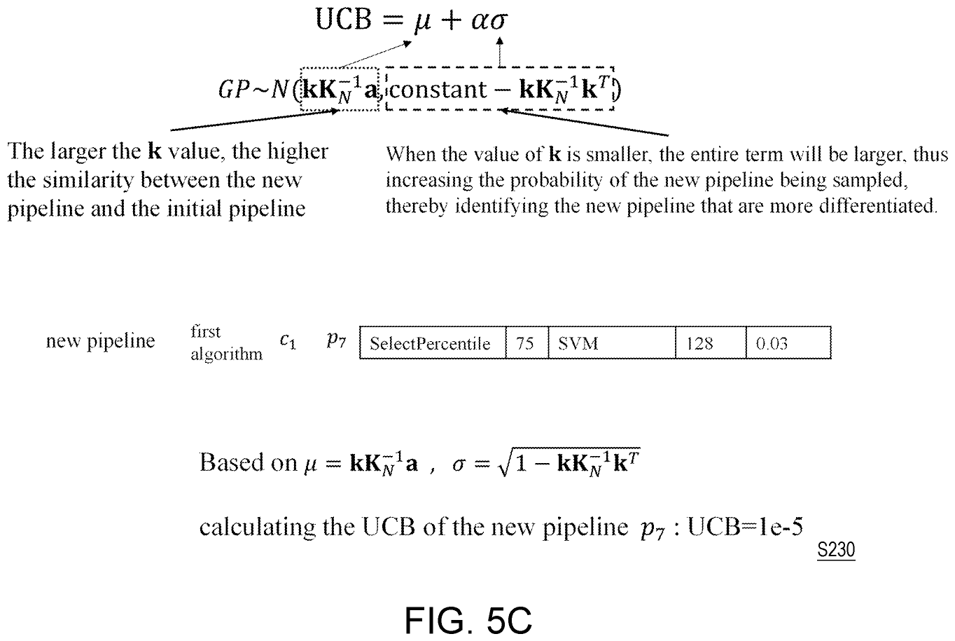

FIGS. 5A to 5C are an implementation example of step S230 shown in FIG. 2. Please refer to FIG. 1, FIG. 2, FIG. 3, FIG. 4 and FIG. 5A to FIG. 5C at the same time.

As shown in FIG. 5A, the pipeline sampling score calculation module 25 can first predict the performance probability distribution of each pipeline. For example, the pipeline sampling score calculation module 25 can use a kernel-based method (such as Gaussian Process) to calculate an initial pipeline performance probability distribution matrix K_{N}, and can calculate a new pipeline performance distribution matrix k for a specific new pipeline. Furthermore, when calculating the initial pipeline performance probability distribution matrix K_{N} and the new pipeline performance distribution matrix k, the pipeline sampling score calculation module 25 can consider the inter algorithm diversity value (Dᵢⱼ), the inter feature correlation value (Fᵢⱼ) and the intra algorithm hyperparameter distance value (Hᵢⱼ). Then, the pipeline sampling score calculation module 25 can use the inter algorithm diversity value, the inter feature correlation value, and the intra algorithm hyperparameter distance value to establish the hybrid kernel (Kᵢⱼ).

As shown in FIG. 5B, the pipeline sampling score calculation module 25 can receive new pipeline through the transceiver 60. In this embodiment, the new pipeline P₇ corresponds to the first algorithm (the combination of SelectPercentile and SVM). Next, in step S231, the pipeline sampling score calculation module 25 can use the first best accuracy initial pipeline prediction result and the second best accuracy initial pipeline prediction result to obtain the inter algorithm diversity value. In one embodiment, the inter algorithm diversity value can include cosine similarity and contingency table. As explained in the above embodiment of FIG. 4, the first best accuracy initial pipeline prediction result is the first prediction result “0, 1, 1, 0” of the first best accuracy initial pipeline (initial pipeline P₁ and initial pipeline P₃). On the other hand, the second best accuracy initial pipeline prediction result is the second prediction result “0, 0, 1, 0” of the second best accuracy initial pipeline (initial pipeline P₆). In this embodiment, since the new pipeline P₇ corresponds to the first algorithm (the combination of SelectPercentile and SVM), the pipeline sampling score calculation module 25 can use the first prediction result “0, 1, 1, 0” and the second prediction result “0, 0, 1, 0” to obtain the inter algorithm diversity value D₇₆. For example, the pipeline sampling score calculation module 25 can use the cosine similarity between the first prediction result “0, 1, 1, 0” and the second prediction result “0, 0, 1, 0” as the inter algorithm diversity value D₇₆.

Please continue to refer to FIG. 5B. As explained in the embodiment of FIG. 4 above, the dataset can include a plurality of features (i.e., features f₁, features f₂, and features f₃). The initial feature set can correspond to the initial pipeline, and the initial feature set can include at least one of the plurality of features. On the other hand, a new feature set can correspond to the new pipeline, and the new feature set can include at least one of the plurality of features. Next, in step S232, the pipeline sampling score calculation module 25 can use the initial feature set and the new feature set to obtain the inter feature correlation value. In one embodiment, the inter feature correlation value can include an absolute value of a Pearson correlation coefficient, an absolute value of a Spearman correlation coefficient, a feature intersection number divided by a total number of features, a Euclidean Distance, and a Mahalanobis Distance. Specifically, as shown in FIG. 5B, it is assumed that the initial feature set corresponding to the initial pipeline P₆ is features f₁ and features f₂, and it is assumed that the new feature set corresponding to the new pipeline P₇ is features f₂ and features f₃. For example, the pipeline sampling score calculation module 25 can use the feature intersection number (i.e., the above-mentioned feature intersection number and the total feature number) to obtain the inter feature correlation value F₇₆.

Please continue to refer to FIG. 5B. In step S233, the pipeline sampling score calculation module 25 can use the initial hyperparameter and the new hyperparameter to obtain the intra algorithm hyperparameter distance value. Specifically, the initial hyperparameter can correspond to the initial pipeline. On the other hand, the new hyperparameter can correspond to the new pipeline. Furthermore, the intra algorithm hyperparameter distance value can include a Radial Basis Function kernel (RBF kernel), a Laplace kernel, a Matern kernel, and a Rational Quadratic kernel. Specifically, the new pipeline P₇ in this embodiment corresponds to the first algorithm (the combination of SelectPercentile and SVM), and the initial pipeline P₆ corresponds to the second algorithm (the combination of SelectPercentile and RF). In other words, the algorithm of the new pipeline P₇ is different from the algorithm of the initial pipeline P₆, so the pipeline sampling score calculation module 25 can obtain intra algorithm hyperparameter distance value H₇₆ as 0. It is worth mentioning that the formula

$$exp ( \frac{- {‖ {h}_{i} - {h}_{j} ‖}_{2}^{2}}{2 {l}^{2}} )$$

in step S233 is an implementation example of the above-mentioned Radial Basis Function kernel.

After the pipeline sampling score calculation module 25 executes the above step S231, step S232, and step S233, the pipeline sampling score calculation module 25 can use the inter algorithm diversity value, the inter feature correlation value, and the intra algorithm hyperparameter distance value to establish a hybrid kernel. In detail, the pipeline sampling score calculation module 25 can obtain the initial pipeline performance probability distribution matrix K₆ and the new pipeline performance distribution matrix k as shown in FIG. 5B.

Please refer to FIG. 5C. After the hybrid kernel is established, the pipeline sampling score calculation module 25 can use a sampling function and the hybrid kernel to obtain the sampling score corresponding to the new pipeline. In one embodiment, the sampling function can include an Expected Improvement (EI), an Upper Confidence Bound (UCB), a Probability of Improvement (POI), and an Entropy Search (ES). As shown in FIG. 5C, the pipeline sampling score calculation module 25 can, for example, obtain the sampling score corresponding to the new pipeline P₇ as UCB value le-5.

Please return to FIG. 2. In step S240, the pipeline recommendation module 27 can use the sampling score to determine a recommended new pipeline in the new pipeline.

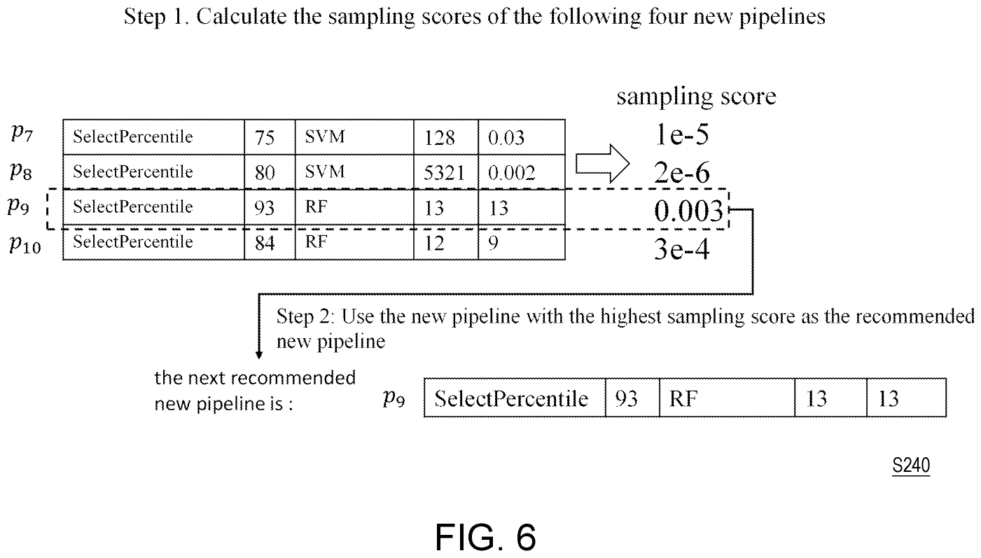

FIG. 6 is an implementation example of step S240 shown in FIG. 2. Please refer to FIG. 1, FIG. 2, FIG. 3, FIG. 4, FIG. 5A to FIG. 5C and FIG. 6 at the same time. In this embodiment, it is assumed that the pipeline sampling score calculation module 25 receives the new pipeline P₇, the new pipeline P₈, the new pipeline P₉ and the new pipeline P₁₀ through the transceiver 60, and it is assumed that the pipeline sampling score calculation module 25 has calculated the sampling scores of the new pipeline P₇, the new pipeline P₈, the new pipeline P₉ and the new pipeline P₁₀ as shown in FIG. 6. The pipeline recommendation module 27 can use the new pipeline with the highest sampling score as the recommended new pipeline. In other words, the pipeline recommendation module 27 can determine that the recommended new pipeline is the new pipeline P₉.

Please return to FIG. 2. The pipeline recommendation module 27 can use a preset execution time and the sampling score to determine the recommended new pipeline in the new pipeline. Specifically, in step S250, the pipeline recommendation module 27 can determine whether steps S220 to S240 have been executed for more than the preset execution time.

If the pipeline recommendation module 27 determines that steps S220 to S240 have not been executed for more than the preset execution time (the determination result of step S250 is “No”), the device 1 of the present disclosure can re-execute step S220.

On the other hand, if the pipeline recommendation module 27 determines that steps S220 to S240 have been executed for more than the preset execution time (the determination result of step S250 is “yes”), then in step S260, the ensemble model recommendation module 29 can use an ensemble learning method to select a target recommended new pipeline from the recommended new pipelines.

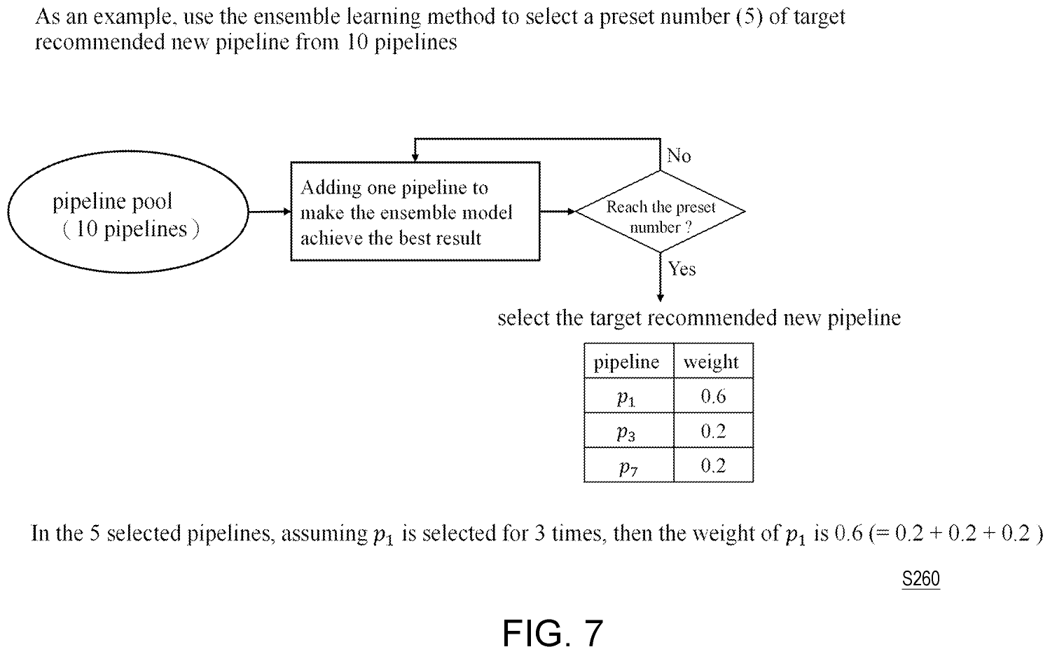

FIG. 7 is an implementation example of step S260 shown in FIG. 2. Please refer to FIG. 1, FIG. 2, FIG. 3, FIG. 4, FIG. 5A to FIG. 5C, FIG. 6 and FIG. 7 at the same time. The ensemble model recommendation module 29 can use a preset number and an ensemble learning method to select the target recommended new pipeline from the recommended new pipelines. For example, assume that the preset number is 5, and assume that the pipeline pool includes the initial pipeline (initial pipeline P₁ to initial pipeline P₆) and new pipeline (new pipeline P₇ to new pipeline P₁₀) in the previous embodiment. The ensemble model recommendation module 29 can use an ensemble learning method to select 5 target recommended new pipelines so that the ensemble model can achieve the best result. For example, as shown in FIG. 7, assume that the ensemble model recommendation module 29 selects the initial pipeline P₁ for a total of 3 times, the ensemble model recommendation module 29 selects the initial pipeline P₂ for a total of 1 time, and the ensemble model recommendation module 29 selects the initial pipeline P₇ for a total of 1 time. Based on this assumption, the weight of the initial pipeline P₁ can be 0.6, the weight of the initial pipeline P₂ can be 0.2, and the weight of the new pipeline P₇ can be 0.2.

Tables 1 and 2 show the performance of the present disclosure on classification and regression datasets. Compared with the international open source software AutoSklearn and the well-known commercial software H2O, the present disclosure can recommend pipelines with similar accuracy for the ensemble model while significantly reducing the number of attempts.

TABLE 1
Classification Result: Accuracy (Number of Trials)

Datasets

| Method/Tool | Diabetes | Adult |
|---|---|---|
| The present | 79.8% (75) | 86.8% (21) |
| disclosure | | |
| AutoSklearn | 80.3% (157) | 86.8% (54) |
| H2O | 78.5% (580) | 86.3% (29) |

TABLE 2
Regression Result: Root of Mean Square Error (Number of Trials)

| | Datasets |
|---|---|
| Method/Tool | Forest |
| The present | 64.1 (414) |
| disclosure | |
| AutoSklearn | 98.8 (1410) |
| H2O | 65.0 (1057) |

In summary, the device and the method for recommending pipelines for an ensemble model of the present disclosure can generate an initial pipeline and obtain the prediction results and the accuracy of the initial pipeline, and then use the inter algorithm diversity value, the inter feature correlation value, and the intra algorithm hyperparameter distance value to obtain the sampling score of the new pipeline. Then, the sampling score of the new pipeline can be used to recommend pipeline for the ensemble model. In this way, the device and the method for recommending pipelines for an ensemble model of the present disclosure can more accurately obtain the sampling score of the new pipeline, thereby more accurately recommending the pipeline for the ensemble model.

What is claimed is:

1. A device for recommending pipelines for an ensemble model, including:
a storage medium, storing a plurality of modules, wherein the plurality of modules includes a data acquisition and pipeline initialization module, a pipeline performance evaluation module, a pipeline sampling score calculation module, a pipeline recommendation module and an ensemble model recommendation module; and
a processor, coupled to the storage medium, and accessing and executing the plurality of modules, wherein
the data acquisition and pipeline initialization module use at least one algorithm to generate at least one initial pipeline;
the pipeline performance evaluation module uses a dataset to obtain at least one prediction result corresponding to the initial pipeline, and uses the dataset to obtain at least one accuracy corresponding to the initial pipeline;
the pipeline sampling score calculation module uses the prediction result, the accuracy, and a new pipeline to obtain at least one inter algorithm diversity value, at least one inter feature correlation value, and at least one intra algorithm hyperparameter distance value, and the pipeline sampling score calculation module uses the inter algorithm diversity value, the inter feature correlation value, and the intra algorithm hyperparameter distance value to obtain at least one sampling score corresponding to the new pipeline;
the pipeline recommendation module uses the sampling score to determine a recommended new pipeline in the new pipeline;
the ensemble model recommendation module uses an ensemble learning method to select at least one target recommended new pipeline from the recommended new pipelines.

2. The device of claim 1, further including a transceiver coupled to the processor, wherein
the data acquisition and pipeline initialization module receive the algorithm, at least one hyperparameter range, an initial number, a preset number of target pipeline and a training time through the transceiver;
the data acquisition and pipeline initialization module use the algorithm, the hyperparameter range, the initial number, the preset number of target pipeline, and the training time to generate the initial pipeline.

3. The device of claim 1, wherein
the pipeline sampling score calculation module uses a first best accuracy initial pipeline prediction result and a second best accuracy initial pipeline prediction result to obtain the inter algorithm diversity value.

4. The device of claim 3, wherein an initial hyperparameter corresponds to the initial pipeline, wherein
the algorithm includes a first algorithm and a second algorithm, wherein the first algorithm is different from the second algorithm;
the initial pipeline includes a first initial pipeline and a second initial pipeline;
the initial hyperparameter include a first initial hyperparameter and a second initial hyperparameter;
the first initial pipeline includes the first initial hyperparameter corresponding to the first algorithm, and the second initial pipeline includes the second initial hyperparameter corresponding to the second algorithm;
the prediction result includes a first prediction result and a second prediction result, and the accuracy includes a first accuracy and a second accuracy;
the first prediction result corresponds to the first initial pipeline, and the first accuracy corresponds to the first initial pipeline, the second prediction result corresponds to the second initial pipeline, and the second accuracy corresponds to the second initial pipeline;
the first initial pipeline includes a first best accuracy initial pipeline and at least one first other initial pipeline, wherein the first accuracy of the first best accuracy initial pipeline is greater than the first accuracy of the first other initial pipeline, wherein the first best accuracy initial pipeline corresponds to the first best accuracy initial pipeline prediction result;
the second initial pipeline includes a second best accuracy initial pipeline and at least one second other initial pipeline, wherein the second accuracy of the second best accuracy initial pipeline is greater than the second accuracy of the second other initial pipeline, wherein the second best accuracy initial pipeline corresponds to the second best accuracy initial pipeline prediction result.

5. The device according to claim 1, further including a transceiver coupled to the processor, wherein the dataset includes a plurality of features, wherein an initial feature set corresponds to the initial pipeline, and the initial feature set includes at least one of the plurality of features, wherein
the data acquisition and pipeline initialization module receive the dataset through the transceiver;
the pipeline sampling score calculation module receives the new pipeline through the transceiver, wherein a new feature set corresponds to the new pipeline, and the new feature set includes at least one of the plurality of features;
the pipeline sampling score calculation module uses the initial feature set and the new feature set to obtain the inter feature correlation value.

6. The device of claim 1, wherein an initial hyperparameter corresponds to the initial pipeline, wherein a new hyperparameter corresponds to the new pipeline, wherein
the pipeline sampling score calculation module uses the initial hyperparameter and the new hyperparameter to obtain the intra algorithm hyperparameter distance value.

7. The device of claim 1, wherein
the pipeline sampling score calculation module uses the inter algorithm diversity value, the inter feature correlation value, and the intra algorithm hyperparameter distance value to establish a hybrid kernel;
the pipeline sampling score calculation module uses a sampling function and the hybrid kernel to obtain the sampling score corresponding to the new pipeline.

8. The device of claim 7, wherein the sampling function includes an Expected Improvement (EI), an Upper Confidence Bound (UCB), a Probability of Improvement (POI), and an Entropy Search (ES).

9. The device of claim 1, wherein the algorithm includes a feature selection algorithm and a model algorithm.

10. The device of claim 1, wherein
the pipeline performance evaluation module uses a kernel-based method and the dataset to obtain the prediction result, and uses the kernel-based method and the dataset to obtain the accuracy.

11. The device of claim 1, wherein the inter algorithm diversity value includes a cosine similarity and a contingency table.

12. The device of claim 1, wherein the inter feature correlation value includes an absolute value of a Pearson correlation coefficient, an absolute value of a Spearman correlation coefficient, a feature intersection number divided by a total feature number, a Euclidean Distance, and a Mahalanobis Distance.

13. The device of claim 1, wherein the intra algorithm hyperparameter distance value includes a Radial Basis Function kernel (RBF kernel), a Laplace kernel, a Matern kernel, and a Rational Quadratic kernel.

14. The device of claim 1, wherein
the pipeline recommendation module uses a preset execution time and the sampling score to determine the recommended new pipeline in the new pipeline.

15. The device of claim 1, wherein
the ensemble model recommendation module uses a preset number and an ensemble learning method to select the target recommended new pipeline from the recommended new pipelines.

16. A method for recommending pipelines for an ensemble model, applicable to a device including a storage medium and a processor, wherein the storage medium stores a plurality of modules, wherein the plurality of modules include a data acquisition and pipeline initialization module, a pipeline performance evaluation module, a pipeline sampling score calculation module, a pipeline recommendation module and an ensemble model recommendation module, wherein the method includes following steps:
using, by the data acquisition and pipeline initialization module, at least one algorithm to generate at least one initial pipeline;
using, by the pipeline performance evaluation module, a dataset to obtain at least one prediction result corresponding to the initial pipeline, and using the dataset to obtain at least one accuracy corresponding to the initial pipeline;
using, by the pipeline sampling score calculation module, the prediction result, the accuracy, and a new pipeline to obtain at least one inter algorithm diversity value, at least one inter feature correlation value and at least one intra algorithm hyperparameter distance value, and using, by the pipeline sampling score calculation module, the inter algorithm diversity value, the inter feature correlation value, and the intra algorithm hyperparameter distance value to obtain at least one sampling score corresponding to the new pipeline;
using, by the pipeline recommendation module, the sampling score to determine a recommended new pipeline in the new pipeline; and
using, by the ensemble model recommendation module, an ensemble learning method to select at least one target recommended new pipeline from the recommended new pipelines.

17. The method of claim 16, wherein using, by the pipeline sampling score calculation module, the prediction result, the accuracy, and the new pipeline to obtain the inter algorithm diversity value, the inter feature correlation value and the intra algorithm hyperparameter distance value includes:
using, by the pipeline sampling score calculation module, a first best accuracy initial pipeline prediction result and a second best accuracy initial pipeline prediction result to obtain the inter algorithm diversity value.

18. The method of claim 16, wherein the device further includes a transceiver, wherein the dataset includes a plurality of features, wherein an initial feature set corresponds to the initial pipeline, and the initial feature set includes at least one of the plurality of features, wherein using, by the pipeline sampling score calculation module, the prediction result, the accuracy, and the new pipeline to obtain the inter algorithm diversity value, the inter feature correlation value and the intra algorithm hyperparameter distance value includes:
receiving, by the data acquisition and pipeline initialization module, the dataset through the transceiver;
receiving, by the pipeline sampling score calculation module, the new pipeline through the transceiver, wherein a new feature set corresponds to the new pipeline, and the new feature set includes at least one of the plurality of features; and
using, by the pipeline sampling score calculation module, the initial feature set and the new feature set to obtain the inter feature correlation value.

19. The method of claim 16, wherein an initial hyperparameter corresponds to the initial pipeline, wherein a new hyperparameter corresponds to the new pipeline, wherein using, by the pipeline sampling score calculation module, the prediction result, the accuracy, and the new pipeline to obtain the inter algorithm diversity value, the inter feature correlation value and the intra algorithm hyperparameter distance value includes:
using, by the pipeline sampling score calculation module, the initial hyperparameter and the new hyperparameter to obtain the intra algorithm hyperparameter distance value.

20. The method of claim 16, wherein using, by the pipeline sampling score calculation module, the inter algorithm diversity value, the inter feature correlation value, and the intra algorithm hyperparameter distance value to obtain the sampling score corresponding to the new pipeline includes:
using, by the pipeline sampling score calculation module, the inter algorithm diversity value, the inter feature correlation value, and the intra algorithm hyperparameter distance value to establish a hybrid kernel; and
using, by the pipeline sampling score calculation module, a sampling function and the hybrid kernel to obtain the sampling score corresponding to the new pipeline.
